(19) United States
(12) Patent Application Publication
(10) Pub. No.: US 2010/0176910 A1
(43) Pub. Date: Jul. 15, 2010

(54) FUSIBLE ALLOY ELEMENT, THERMAL FUSE WITH FUSIBLE ALLOY ELEMENT AND METHOD FOR PRODUCING A THERMAL FUSE

(76) Inventors: Norbert Knab, Appenweier (DE); Georg Schulze-Icking-Konert, Buehlertal (DE); Thomas Mohr, Buehlertal (DE); Stefan Kotthaus, Sinzheim (DE); Nikolas Haberl, Sinzheim (DE); Stefan Stampfer, Bietigheim-Bissingen (DE); Michael Mueller, Rutesheim (DE)

Correspondence Address: MERCHANT & GOULD PC, P.O. BOX 2903, MINNEAPOLIS, MN, 55402-0903, US

(21) Appl. No.: 12/593,120

(22) PCT Filed: Feb. 1, 2008
(86) PCT No.: PCT/EP08/51244

§ 371 Date: Mar. 23, 2010

(30) Foreign Application Priority Data
Mar. 26, 2007 (DE) 102007 014 334.8

(51) Int. Cl. H01H 37/76; H01H 69/02

(52) U.S. Cl. 337/290; 29/623

(57) ABSTRACT

The invention relates to a fusible alloy element (1), in particular for producing a thermal fuse, comprising a fusible element (2), which is made of a material that melts at a trigger temperature, and a support layer (4) on a surface in at least one contacting area of the fusible alloy element (1). According to the invention, the melting temperature of the material of the support layer (4) is greater than the trigger temperature, wherein the material of the support layer (4) is selected such that it dissolves in its solid status in the melted material of the fusible element (2)

The invention relates to fusible alloy elements, in particular for the use in thermal fuses, in order to protect modules, in particular control units in high current applications against overheating.

In order to protect electric modules against overheating irreversible thermal fuses are required, which interrupts (trigger) a current conducting conductor at a too high ambient temperature. The thermal fuses are thereby so construed, that the trigger temperature is not reaches due to a possibly occurring current floe, so that it is ensured that they can be triggered not by a too high current, but exclusively by a too high ambient temperature. Thus a thermal fuse serves for providing an independent switch-off path for electric modules, which securely interrupts the current flow at improperly high temperatures in the module, for example due to failures of components, shorts, for example by external influences, malfunctioning of isolation materials and such alike.

Usual thermal fuses are mostly based on the concept of a fixed spring (for example a soldered leaf spring), whereby the thermal fuse is opened by the spring force. But also in normal operation, which means in closed state of the thermal fuse, a mechanic force exerts on the connection point, which can cause quality issues, especially at long operating times in the automotive field, for example to a disruption of the solder point.

An alternative embodiment of a thermal fuse uses a conductive fusible material, which begins to melt at a triggering temperature and interrupts thereby a connection.

At thermal fuses, which use a fusible material, it has to be paid attention to the danger that it is for example at least partially melted when soldering the fusible alloy element already during the mounting of the thermal fuse, so that the current path is interrupted. Thereby the thermal fuse would already become useless before using it.

Therefore it has either to be ensured at a soldering process for attaching such a fusible alloy element that the fusible alloy element is only melted locally, which requires a very accurate controlling of the soldering process. At a local melting of the fusible alloy element for attaching at connection points furthermore cold soldering points can develop, which significantly impact the process security and the quality of the electric connection. Or a suitable solder with a melting temperature below the melting temperature of the fusible alloy element is used, in order to solder the fusible alloy element. But that requires a special solder, whose possible triggering temperature has to lie significantly below the melting temperature of the fusible alloy element.

It is the task of the invention to provide a thermal fuse and a fusible alloy element, which securely interrupts the current flow by melting at improperly high temperatures due to failures of components, malfunctioning of isolation material, whereby the triggering mechanism shall thereby basically depend on the ambient temperature and not on the current, so that even failures, which only cause currents, which are lower than the permissible maximum currents, can be securely detected. In particular it shall be ensured that the thermal fuse can be easily created by equipping a punched grid with a fusible alloy element, without already causing a complete or partial melting of the fusible alloy element at the processing during the production.

This task is solved by the fusible alloy element according to claim 1, the thermal fuse, the use of the fusible alloy element as well as by the procedure for producing of a thermal fuse according to the subordinate claims.

Further advantageous configurations of the invention are stated in the dependant claims.

According to a first aspect a fusible alloy element is provided in particular for producing a thermal fuse. The fusible alloy element comprises a fusible element consisting of a material that melts at a triggering temperature; and a support layer on a surface at least in one of the contacting areas of the fusible alloy element. A melting temperature of the material of the support layer is higher than the triggering temperature, whereby the material of the support layer is so selected that it dissolved in solid state in the melted material of the fusible element.

A fusible alloy element can be produced thereby, which can be mounted in more simple and reliable, because it provides an increased resistance against high temperatures during soldering or another mounting process. The process temperature during mounting of the fusible alloy element does not immediately cause a melting of the fusible alloy element, because contracting of the material of the fusible element that melted at the process temperature is prevented by reducing the surface tension. With other words, a contracting of the melted material of the fusible element causes no production of energy due to its surface tension when providing the support layer. The support layer is furthermore so construed that it does not permanently obstruct the melting of the fusible alloy element, because the material of the support layer can dissolve in the material of the fusible element.

Furthermore the material of the fusible element can contain tin and the material of the support layer copper.

According to an embodiment the fusible element is construed in the form of a rectangular to provide a defined current distribution when using it as thermal fuse.

Furthermore the support layer is construed continuously on the surface. The support layer can in particular be construed on the surface and an opposite surface of the fusible element and especially completely enclose the fusible element.

According to an embodiment the thickness and the material of the support layer can be so selected, in order not to melt completely in the melted material of the fusible element at a melted material of the fusible element before a certain period of time.

Furthermore one or several additional layers can be provided on the surface, which comprise at least one of the layers: soldering layer, corrosion layer and adhesion-improving layer.

According to a further aspect a thermal fuse is provided with a connection point on a punched grid and with the above fusible alloy element, which is attached, in particular soldered to the surface at the connection point.

Furthermore it is provided to use the fusible alloy element in a current path of a thermal fuse.

According to a further aspect a procedure for producing a thermal fuse is provided with the steps of placing a contact material, in particular a solder on a connection point; the placing of the above fusible alloy element, so that at least one area of the support layer lies on the contacting material; the heating of the contact material on and above its melting point, so that the contact material connects with the material of the support layer and the connection point, for a period of time after which the material of the support layer is completely dissolved in the melted material of the fusible element and the contact material.

### DRAWINGS

Preferred embodiments of the invention are subsequently explained with the aid of the attached drawings. It is shown in:

FIG. 1a to 1e embodiments for fusible alloy elements according to different embodiments of the present invention;

FIG. 2 a further embodiment of the fusible alloy element according to the present invention;

FIGS. 3a to 3b an illustration of the procedure for attaching the fusible alloy element on a punched grid

FIG. 3c an illustration of the thermal fuse in a state after triggering.

### EMBODIMENTS OF THE INVENTION

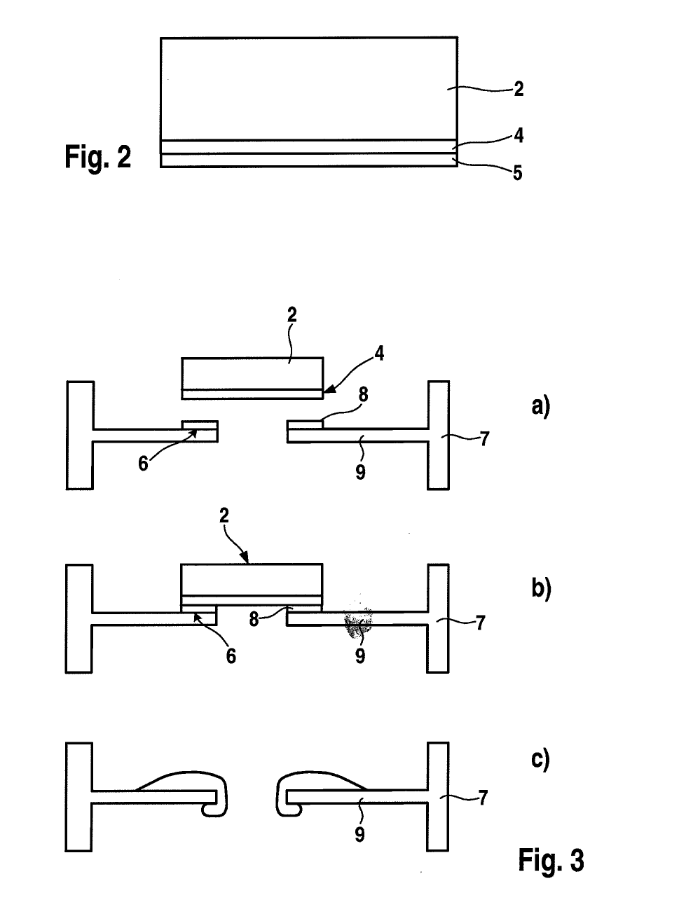

According to the invention the fusible alloy element 1 comprises basically a block in the form of a bar with a fusible alloy element 2 made of a fusible material. The fusible element 2 contains a metal or another electrically well conducting alloy or material, through which a current flows, if the fusible alloy element 1 is built into a thermal fuse (see FIG. 3a-3c). The fusible alloy element 1 warms up only slightly compared to the environment at a maximally allowed current flow by a sufficiently big cross section of the fusible alloy element, a sufficiently low specific resistance as well as a good thermal connection to the environment.

The melting point of the material of the fusible element 2 is so selected that the block melts at a temperature increase due to operating disturbances, for example failures of electronic components, malfunctioning of the isolation materials, shorts by external influences above a melting temperature and thereby interrupts a current path that exists in the fusible alloy element.

The fusible alloy element 1 is placed and for example soldered between two connection points that are electrically isolated from each other. When soldering the fusible alloy element 1 it has to be paid attention to the fact that the fusible alloy element 1 does not interrupt the current path already during the mounting, which can occur if a temperature would be applied thereby, which is equal to or higher than the melting temperature of the fusible element 2.

Therefore it has either be ensured that the fusible alloy element 1 is either only melted locally during the soldering process either when attaching and connecting with the connection points or soldered with the aid of a solder with a melting point, which is lower than the melting point of the fusible element 2.

In order to simplify the production process of a thermal fuse with such a fusible alloy element 1 a support layer 4 is provided, with which the fusible alloy element 1 is place or rather soldered on the connection points. The support layer 4 provides a high melting point, which is higher than the melting point of the fusible material 2 and the solder, which is used at the soldering process. The support layer 4 is furthermore made of a material, which slowly dissolves in the material of the fusible element 2, which can go into solution. Possible material systems for the fusible element 2 can be materials with a sufficient tin rate, for example more than 30%, more than 50%, more than 70% and in particular preferably more than 80%. The material of the support layer 4 can be copper or a copper alloy with a high copper rate, as for example more than 70%. Copper is advantageous, because it already dissolves in solid state in liquid tin, whose temperature corresponds with its melting temperature, with approximately 10 μm/min, whereby this value is doubled for each 10 K temperature increase above the melting temperature. Other material systems for the materials of the fusible element 2 and the support layer 4 are also possible.

When placing the fusible alloy element 1 on corresponding connection points a usual solder is therefore used, for example the same material as the material of the fusible element 2. The fusible element 2 of the fusible alloy element 1 melts thereby completely or partially and the material of the support layer 4 begins to melt in the material of the melted fusible element 2. The soldering process should be finished before the support layer is completely melted. As long as the support layer 4 is not yet completely melted in the melted fusible element it prevents the contracting of the fusible alloy element 1 on one or several of the connecting points by reducing the surface tension. The thickness of the support layer 4 and the duration of the soldering process for attaching the fusible alloy element 1 at the connection points have to be so selected that only one part of the support layer 4 melts, so that the current path is not interrupted despite a melting down or melting together of the fusible element 2.

In the case of a triggering the support layer 4 that remains after the soldering process during the mounting dissolves in the melted material of the fusible element 2 after the melting of the fusible alloy element 1 after the melting of the fusible alloy and the fusible alloy element 1 interrupts the current path thereby that parts of the melted material accumulate at the connection point for example in the form of drops due to the surface tension of the melted material.

The delay of the responding at a temperature above the melting temperature of the fusible element shall thereby be as short as possible in the end application.

In comparison with a soldering with a solder with a low melting point the advantage this invention is that the contacting of the fusible alloy element 1 can be created at the connection points with the same solder as the fusible alloy, so that also thermal fuses with low triggering temperatures can be selected thereby, because no temperature difference has to be provided between the melting temperature f the solder for attaching the fusible alloy element 1 at the connection points and the fusible material of the fusible element.

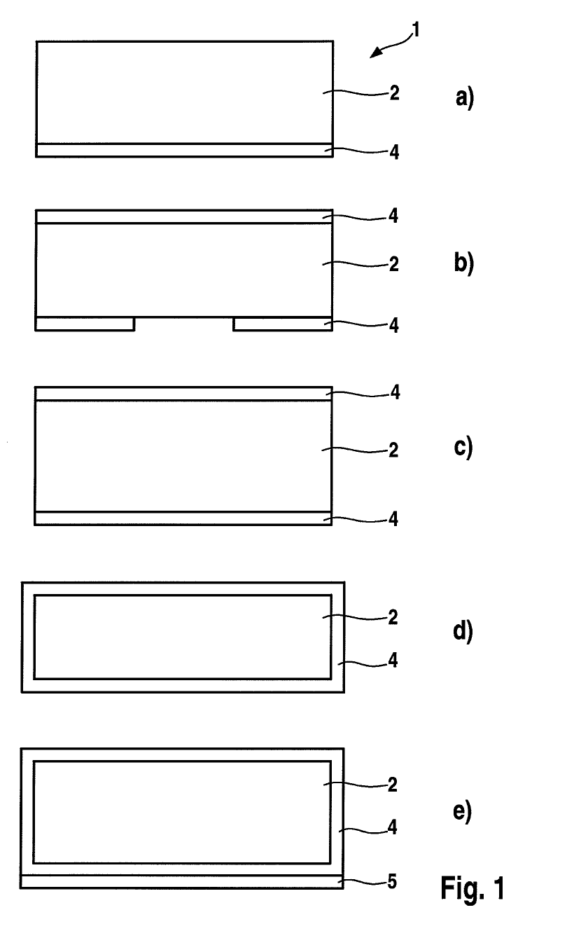

FIG. 1a to 1e show different configurations of the fusible alloy element 1. As it is shown in FIG. 1a the fusible alloy element 1 provides a fusible element 2, on whose ne side the support layer 4 is placed. The support layer 4 is placed on the side of the melting element, which is connected or soldered to the connection points in a subsequent mounting process for a thermal fuse.

Besides the embodiment of the fusible alloy element of FIG. 1a further embodiments are possible, which distinguish themselves in their arrangement. The support layer 4 is not placed flatly in FIG. 1b on the surface of the fusible elements 2, with which the fusible alloy element 1 is mounted, but only in the areas, which have to be connected to the connection points. This means the support layer 4 is for example interrupted in a centered area. But a continuous support layer 4 is provided on the opposite surface and/or on a side in order to cause the effect of preventing the contracting of the melted material of the fusible element.

As it can be seen in the embodiments of FIG. 1c to 1e support layers 4 can be provided on both sides of the fusible element 2 (or on two or more than two different surfaces, which span between the contacting point of the fusible alloy element 1), in order to cause a triggering of the thermal fuse that is created by the fusible alloy element 1 not until a complete melting of the fusible element 2 and a subsequent dissolving of the material of the support layer 4 in the material of the melted fusible element 2.

Furthermore it can be provided according to the embodiment in FIG. 1d that the fusible element 2 is completely surrounded by support layers 4, so that a flowing of the material of the fusible element 2 out of the area between the support layers 4 that are on opposing surfaces can be avoided. By this means it can be avoided that the opposing support layers 4 approach each other, come into contact with each other and then cannot dissolve anymore, because there is no melted material of the fusible element 2 anymore, whereby a separating of the thermal fuse is possibly prevented.

FIG. 1 e shows based on the embodiment in FIG. 1d that in addition to the support layer also one or several further layers can be provided, which have a corresponding additional function. An extract from the fusible alloy element 1 of FIG. 1e is for example shown in figure. There it can be seen that the support layer 4 as well as additional layers 5 are placed on the fusible element 2.

The additional layer 5 can for example be a soldering layer, which makes an additional provision of a soldering paste and such alike for soldering the fusible alloy element 1 between the connection points redundant. A soldering of the fusible alloy element 1 can take place by placing the fusible alloy element 1 on the connection points and a corresponding heating.

Furthermore the additional layer 5 can be additionally or alternatively an oxidization layer for the support layer 4, in order to create a higher corrosion resistance. Possible materials therefore are for example Entec or SnAgCu.

The additional layer 5 can furthermore be alternatively or additionally an adhesion-improving layer, which for example provides Ni or Au, in order to simplify a gluing or bonding of the fusible alloy element 1 at the connection points at an alternative form of placing. Furthermore the additional layer or one f them can contain a soldering flux. Preferably the materials of the one or several additional layers are so selected that they also dissolve at the melting of the fusible element 2, or melt or evaporate due to the process temperature.

FIGS. 3a and 3b show a mounting process for a thermal fuse. FIG. 3a shows a state of the procedure, which shows a fusible alloy element 1 of the embodiment in FIG. 1a right before the placing on connection points 6 of conductor area 9 of a punched grid 7. The connection points 6 of the punched grid 7 are provided with a soldering paste 8. The fusible alloy element is placed on the soldering paste 8 and subsequently the soldering paste 8 is warmed up above its melting temperature. Thereby also the fusible element 2 warms up and the support layer 4 of the fusible alloy element 1 dissolves in the soldering paste 8 as well as in the fusible element 2 as long as the fusible element 2 is also melted.

This is made clear in FIG. 3b thereby that in areas, where the fusible element 2 is soldered at the connection points, the support layer is thinner than at the other areas. The thickness of the support layer 4 and the materials of the fusible element and the support layer 4 are so selected, that a reliable attaching of the fusible alloy element 1 at the connection points for example by soldering can be achieved, without the support layer 4 getting completely melted in the melted part of the fusible element 2. Thereby the reliability of the soldering process would be impaired because an interruption of the current path through the fusible alloy element 1 of the thermal fuse can occur thereby. But the thickness is thereby limited that in the case of a triggering the material of the support layer 4 dissolves—if possible—completely in the melted material of the fusible element in a short period of time, for example 1 to 10 seconds. With the thickness the idleness of the thermal fuse can be adjusted.

FIG. 3c shows a thermal fuse after a triggering, at which the fusible alloy is melted due to a high ambient temperature and the support layer 4 has dissolved in the melted fusible element 2. Due to the surface tension parts of the melted fusible alloy are pulled to the conducting areas 9, where they contract to drops due to its surface tension. Due to the surface tension and the affinity of the melted material of the fusible element 2 to contract on the conducting areas 9, the melted material of the fusible element 2 is pulled out of the area between the conducting areas 9 and there separated.

1-10. (canceled)

11. A fusible alloy element for producing a thermal fuse, comprising:
a fusible element comprising a material that melts at a triggering temperature; and
a support layer on a surface at least in one contacting area of the fusible alloy element;
wherein a melting temperature of the material of the support layer is higher than the triggering temperature, and wherein the material of the support layer is selected such that it goes into solution in the melted material of the fusible element in solid state.

12. The fusible alloy element of claim 11, wherein the material of the fusible alloy element comprises tin and the material of the support layer comprises copper.

13. The fusible alloy element of claim 11, wherein the fusible element is rectangular.

14. The fusible alloy element of claim 11, wherein the support layer is continuous on the surface.

15. The fusible alloy element of the claim 11, wherein the support layer is formed on the surface and encloses the fusible element.

16. The fusible element of claim 11, wherein a thickness and material of the support layer are selected to prevent the melted material of the fusible element to completely dissolve at the melted material of the fusible element before a certain period of time.

17. The fusible alloy element of claim 11, wherein at least one additional layer is provided on the surface that comprises at least one of: a soldering layer; a corrosion layer; and an adhesion-improving layer.

18. The fusible alloy element of claim 11, wherein the fusible alloy element is arranged in a current path of a thermal fuse.

19. A thermal fuse with a connection position on a punched grid and with a fusible alloy element comprising a material that melts at a triggering temperature and a support layer on a surface at least in one contacting area of the fusible alloy element, wherein a melting temperature of the material of the support layer is higher than the triggering temperature, and wherein the material of the support layer is selected such that it goes into solution in the melted material of the fusible element in solid state, wherein the thermal fuse is soldered with the surface at a connection point.

20. A method for producing a thermal fuse, the method comprising:
placing a contact material on a connection point;
placing a fusible alloy element comprising a material that melts at a triggering temperature, and a support layer on a surface at least in one contacting area of the fusible alloy element; wherein a melting temperature of the material of the support layer is higher than the triggering temperature, and wherein the material of the support layer is selected such that it goes into solution in the melted material of the fusible element in solid state, wherein at least one area of the support layer lies on the contact material; and
heating the contact material at least to its melting point, so that the contact material connects with the material of the support layer and the connection point for a period of time, that is limited by the period of time, after which the material of the support layer is completely dissolved in the melted materials of the fusible element and the contact material at the area of the support layer.
